(19) United States
(12) Patent Application Publication
(10) Pub. No.: US 2024/0403630 A1
(43) Pub. Date: Dec. 5, 2024

(54) ADAPTIVE DRIVING STYLE

(71) Applicant: Honda Motor Co., Ltd., Tokyo (JP)

(72) Inventors: Fatemeh KOOCHAKIGHERMEZCHESHME, San Jose, CA (US); Zhaobo ZHENG, Campbell, CA (US); Kumar AKASH, San Jose, CA (US); Teruhisa MISU, San Jose, CA (US)

(21) Appl. No.: 18/328,407

(22) Filed: Jun. 2, 2023

(51) Int. Cl. G06N 3/08

(52) U.S. Cl. CPC G06N 3/08

(57) ABSTRACT

Siamese neural network (SNN) based adaptive driving style prediction may be achieved by calculating a first distance between the input data and a first class of a set of anchor data using a trained SNN, calculating a second distance between the input data and a second class of the set of anchor data using the trained SNN, and generating an adaptive driving style prediction based on the first distance and the second distance. The trained SNN may be trained based on two or more sensor signals received during a training phase, a distance-based loss for the two or more sensor signals from the training phase, and by back-propagating the distance-based loss.

### BACKGROUND

Driving features, such as adaptive cruise control (ACC), lane-keeping assistance system (LKAS), or advanced occupant assistance systems (ADAS) are getting more and more popular on existing vehicles. These features may bring improved convenience and fuel efficiency to individuals and to society. The acceptance and trust of driving features remain a factor. However, users may turn off these features if they do not prefer the control behavior and driving styles provided.

### BRIEF DESCRIPTION

According to one aspect, a system for Siamese neural network (SNN) based adaptive driving style prediction may include a set of two or more sensors, a memory, and a processor. The set of two or more sensors may receive two or more sensor signals. The memory may store one or more instructions. The processor may execute one or more of the instructions stored on the memory to perform one or more acts, actions, or steps. For example, the processor may train a SNN based on two or more of the sensor signals as input and a distance-based loss for the two or more sensor signals and back-propagate the distance-based loss to further train the SNN.

A sensor signal of the two or more of the sensor signals may include a heart rate sensor signal, a gaze sensor signal, a pupil size sensor signal, a grip force sensor signal, a controller area network (CAN) signal, or a foot position sensor signal. The SNN may be a Siamese convolutional neural network (SCNN). The SCNN may include symmetrical convolutional neural networks (CNN). The distance-based loss may be calculated using Euclidean distance. The distance-based loss may be calculated using a contrastive loss function. The training the SNN may include learning a similarity function. The SNN may be trained using one-shot learning. The SNN may be trained based on drive context information as input. The trained SNN may output an adaptive driving style prediction based on two or more sensor signals received during an execution phase.

According to one aspect, a system for Siamese neural network (SNN) based adaptive driving style prediction may include a set of two or more sensors, a memory, and a processor. The set of two or more sensors may receive two or more sensor signals. The memory may store one or more instructions. The processor may execute one or more of the instructions stored on the memory to perform one or more acts, actions, or steps. For example, the processor may calculate a first distance between the input data and a first class of a set of anchor data using a trained SNN, calculate a second distance between the input data and a second class of the set of anchor data using the trained SNN, and generate an adaptive driving style prediction based on the first distance and the second distance. The trained SNN may be trained based on two or more sensor signals received during a training phase, a distance-based loss for the two or more sensor signals from the training phase, and by back-propagating the distance-based loss.

A sensor signal of the two or more of the sensor signals or the two or more of the sensor signals from the training phase may include a heart rate sensor signal, a gaze sensor signal, a pupil size sensor signal, a grip force sensor signal, a controller area network (CAN) signal, or a foot position sensor signal. The trained SNN may be a Siamese convolutional neural network (SCNN). The SCNN may include symmetrical convolutional neural networks (CNN). The distance-based loss may be calculated using Euclidean distance. The distance-based loss may be calculated using a contrastive loss function.

According to one aspect, a computer-implemented method for Siamese neural network (SNN) based adaptive driving style prediction may include calculating a first distance between input data including two or more sensor signals and a first class of a set of anchor data using a trained SNN, calculating a second distance between the input data and a second class of the set of anchor data using the trained SNN, and generating an adaptive driving style prediction based on the first distance and the second distance. The trained SNN may be trained based on two or more sensor signals received during a training phase, a distance-based loss for the two or more sensor signals from the training phase, and by back-propagating the distance-based loss.

A sensor signal of the two or more of the sensor signals or of the two or more of the sensor signals from the training phase may include a heart rate sensor signal, a gaze sensor signal, a pupil size sensor signal, a grip force sensor signal, a controller area network (CAN) signal, or a foot position sensor signal. The SNN may be a Siamese convolutional neural network (SCNN). The SCNN may include symmetrical convolutional neural networks (CNN).

### BRIEF DESCRIPTION OF THE DRAWINGS

FIG. 1 is an exemplary illustration of a component diagram for a system for adaptive driving style prediction, according to one aspect.

FIG. 2 is an exemplary illustration of an architecture for the system for adaptive driving style prediction of FIG. 1, according to one aspect.

FIG. 3 is an exemplary illustration of an architecture for the system for adaptive driving style prediction of FIG. 1, according to one aspect.

FIG. 4 is an exemplary illustration of a flow diagram for a computer-implemented method for adaptive driving style prediction, according to one aspect.

FIG. 5 is an illustration of an example computer-readable medium or computer-readable device including processor-executable instructions configured to embody one or more of the provisions set forth herein, according to one aspect.

FIG. 6 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle (AV) and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A framework or architecture for detecting user driving style preference with multi-modal signals, to adapt autonomous vehicle driving style to drivers' preferences in an automatic manner is provided herein. Mismatch between an automated vehicle driving style and an occupant's preference may lead to frequent takeovers or disabling of automation features. Multi-modal data from human participants on a driving simulator, including eye gaze, steering grip force, driving maneuvers, brake and throttle pedal inputs, foot distance from pedals, pupil diameter, galvanic skin response, heart rate, and situational drive context may be collected during a training phase. Based on the data collected during the training phase, a framework may be built using a Siamese neural network (SNN) to identify preferred driving styles. The model performance may have significant improvement compared to other frameworks. Additionally, the framework may improve model performance without a network training process using data from target users.

This framework may be initially trained using generic user data and further adapted to individual patterns with updated data from an individual as anchor data. One objective achieved may be to satisfy performance with a limited amount of data, while evolving and adapting to occupants' changes or desires over time. The model or neural network(s) (e.g., SNN or SCNN) described herein may take new inputs from the user and adapt to any changes without retraining of the model. The model for user driving style preference may initialize with generic data, and adapt using individualized data. This process may also be accomplished actively on-vehicle, without entering a retraining phase.

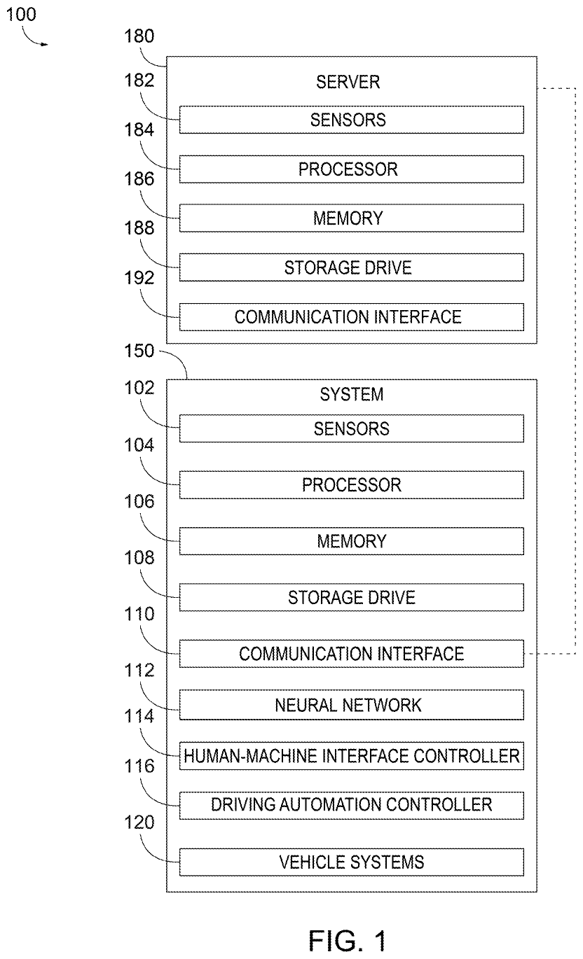

FIG. 1 is an exemplary illustration of a component diagram for a system 100 for adaptive driving style prediction, according to one aspect. The system 100 for adaptive driving style prediction may include a server portion 180 and an execution portion 150. According to one aspect, the server 180 may be where a model or a neural network is trained for use during execution. The server 180 may transmit the model or neural network to the execution portion 150, which may be located on-board an autonomous vehicle (AV), for example.

In any event, the system 100 for adaptive driving style prediction may include the server 180, which may include a set of two or more sensors 182, a processor 184, a memory 186, a storage drive 188, and a communication interface 192. Additionally, the system 100 for adaptive driving style prediction may include the execution portion 150 implemented on an autonomous vehicle (AV), which may include a set of two or more sensors 102, a processor 104, a memory 106, a storage drive 108, a communication interface 110, a neural network 112 (e.g., trained neural network), a human-machine interface (HMI) controller 114, a driving automation controller 116, and one or more vehicle systems 120.

### Training Phase

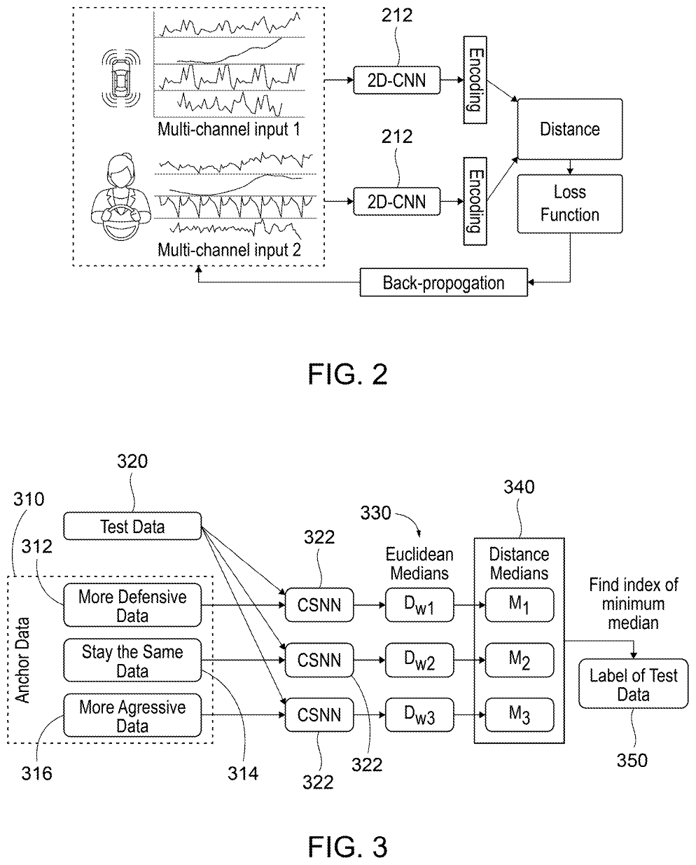

FIG. 2 is an exemplary illustration of an architecture for the system 100 for adaptive driving style prediction of FIG. 1, according to one aspect. With reference to FIGS. 1-2, the training phase may occur on the server 180 remote from the system 100 for adaptive driving style prediction and the trained model or trained Siamese neural network (SNN) may be transmitted to the execution portion 150 and received at the communication interface 110, which may store the trained SNN on the storage drive 108.

During the training phase, the set of two or more sensors 182 may receive two or more sensor signals. A sensor signal of the two or more of the sensor signals (e.g., multi-modal behavioral responses) may include a physiological signal, a heart rate sensor signal, a gaze sensor signal, a pupil size sensor signal, a grip force sensor signal, a controller area network (CAN) signal, or a foot position sensor signal. These sensor signals may be received from individuals who are driving or operating an autonomous vehicle (AV) during the training phase. The operation or activities may occur in a simulated environment (e.g., driving simulator) for the training phase.

For example, participants for the training phase may experience Society of Automotive Engineers (SAE) Level 2 autonomous driving, as the AV may provide longitudinal and lateral control and participants may take over control as desired, through steering wheels and pedals. If a participant takes over, the AV may resume autonomous operation. Different driving styles may be implemented during the simulation. Examples of driving styles may include Highly Defensive (HD), Less Defensive (LD), Less Aggressive (LA), and Highly Aggressive (HA). These driving styles may have varied driving parameters including headway, acceleration, and minimum distance to decelerate (MDD). The AVs used during simulation may utilize an intelligent occupant model (IDM) and Stanley controller parameters for operation.

The AV may have fixed driving style adaptions which may have a consistent driving style, and the AV may have an adaptive driving style which may vary in driving aggressiveness based on the participant responses. Participant responses may be collected, including how their trust in the AV changed during the adaptive driving style, and how they would prefer the AV to drive. The responses may be collected through a questionnaire. Events may occur at intersections during the training phase. Examples of types of events which may occur include pedestrian related events (e.g., pedestrian crossing the intersection), and traffic related events (e.g., ongoing car making a left at an intersection). Questions related to occupants' trust and user driving style preference may be presented after each event, with the system pausing the drive. Responses for the trust in the system include “greatly increased”, “slightly increased”, “stayed the same”, “slightly decreased”, and “greatly decreased”. The responses for the user driving style preference include “drive more aggressively”, “drive the same”, and “drive more defensively”. After the responses, the system may resume and adapt the driving style based on the responses. For example, if the trust in the system decreased, the system may drive more defensively. If the occupant prefers the system to drive more aggressively, the system may drive more aggressively.

Modalities may be Z-normalized using Equation (1) below for each participant to account for individualized differences, such as resting heart rate and physical body size, etc.

$$Z = \frac{x - μ}{σ} \qquad ( 1 )$$

Each sample may have a label of driving style preference, ranging from more aggressive (MA), more defensive (MD), and stay the same(S). The labels may be collected from the questionnaire associated with each event.

The processor 184 may train a SNN based on two or more of the sensor signals and drive context information (e.g., related to the events which occur) as input and a distance-based loss for the two or more sensor signals. The training the SNN may include learning a similarity function and the SNN may be trained using one-shot learning. The distance-based loss may be calculated using Euclidean distance. The distance-based loss may be calculated using a contrastive loss function. Thus, the distance or Euclidean distance may represent a distance between two classes and the SNN may learn a distance metric indicative of how ‘far’ current data is away from one classification label to another based on the two or more sensor signals. The processor 184 may back-propagate the distance-based loss to further train the SNN.

According to one aspect, the SNN may be a Siamese convolutional neural network (SCNN) or also a convolutional Siamese neural network (CSNN). For example, the SCNN may include symmetrical convolutional neural networks (CNN) 212. Generally, SNNs are a type of neural network architecture that includes two identical networks. The two sub-networks have the same configuration with the same parameters and the same weights. The SNN may learn similarity knowledge by taking pairs of data and computing the differences between their features, to map them within a multi-dimensional feature space. Weight sharing guarantees that two similar samples may not be mapped by their respective networks to different locations in feature space. During the training, the SNN may learn a similarity function instead of attempting to classify inputs, which allows it to be generalized for unseen data. In this way, the model or SNN may be trained.

One benefit or advantage of learning similarity through the SNN, may be that they may be used for small datasets. Thus, the SNN may be trained with limited data size as an initial generic model such as one-shot learning. This learning scheme is beneficial to the future application scenario, where customers may acquire a vehicle with an automatic driving style adaption that used generic model training and may update as it obtains data for the specific customer. Siamese Convolutional Neural Networks (SCNNs) may be SNNs with symmetric Convolutional Neural Networks (CNNs) as sub-networks. According to one aspect, the CNN portion may include two 2D-convolution layers with a kernel size of 27×3 and 9×3, and filter sizes of 32 and 32. After each convolution layer, a max-pooling layer with a pool size of 3×3 and a stride size of 3 may be used.

The inputs of the model or network (e.g., the SNN or SCNN) may be the behavioral responses of the participants and the drive context information. The trained SNN may output an adaptive driving style prediction based on two or more sensor signals received during an execution phase. Examples of adaptive driving style prediction may include having the AV operate more aggressively (MA), more defensively (MD), or having the AV operate the same(S). Thus, the model output may be the predicted preferred driving style change.

Contrastive loss may be a distance-based loss that may be used in SCNN to learn embedding vectors for which two similar points have a low Euclidean distance and two dissimilar points have a high Euclidean distance. Assuming that X₁ and X₂ are given pairs of inputs and their sub-network outputs are respectively F(X₁) and F(X₂). D_{w}(X₁,X₂)=∥F_{w}(X₁)−F_{w}(X₂)∥₂ may be used as a learnable function representing the Euclidean distance between feature embeddings of the input images. The parameters of the SCNN may be trained using the contrastive loss from Equation (2), below.

$$L = ( 1 - Y ) {D}_{w}^{2} + ( Y ) {\{ max ( 0 , m - {D}_{w} ) \}}^{2} \qquad ( 2 )$$

Y=0 may indicate similar inputs (e.g., same class) and Y=1 may indicate dissimilar inputs (e.g., different classes), with the anchor input. A small D_{w} for similar inputs and a large D_{w} for dissimilar inputs may minimize the contrastive loss function. There may be a margin of m>0 around the embedding space of a sample, so dissimilar pairs of samples may only contribute to contrast loss functions if their distances are within a margin. The m value may be set to 2.0 and indicate the maximum D_{w} at which dissimilar paired inputs cannot be trained. With a trained one-shot model, future inputs that contain updated behavioral patterns may be added to the anchor data. In this way, the contrastive loss function may distinguish new inputs, without the need for retraining.

In order to train SNN models, inputs may be formed in pairs, each with a binary label indicating whether they belong to the same class. A pair of multi-channel inputs may be embedded in the feature space following feature extraction and Siamese network fusion. The pairwise distance between two sub-networks and the label of pairs may be input into a contrastive loss function, and the loss values may be calculated for back-propagation. Optimization may be performed with an Adam optimizer.

For SNN training, the occupant data may be randomly partitioned into different folds, with one fold as a testing fold, and others as training folds. Group cross validation may test the model performance on training data from other participants, evaluating the potential of a pre-trained model.

Different sensing modalities may be more impactful on driving style preference prediction, and a study was performed, in which signals from each sensing modality were removed and evaluate the model accuracy loss. For example, CAN-BUS, eye tracking, physiological sensing, grip forces, and foot distance to the pedals may be considered. CAN-BUS signals, including pedal pressings, steering, and event types may have more direct relationships with occupant cognitive states. Eye-tracking features, including gaze behaviors and semantic information, physiological feature information may be utilized. Multi-modal data for occupant state prediction may ensure model robustness.

### Validation

FIG. 3 is an exemplary illustration of an architecture for the system 100 for adaptive driving style prediction of FIG. 1, according to one aspect. For user driving style preference detection validation, each sample may be compared to a pool of randomly selected samples from MA, MD, and S samples. These samples may be used as anchor data. Using the trained SNN, the Euclidean distance may be calculated for each paired input of the sample and the anchor data. The medians of Euclidean distances 330 to each class of anchor data may be computed. The class of anchor data with the smallest Euclidean distance median 340 may be located and the resultant user driving style preference class may be chosen as the label 350 of the test data.

### Test Phase or Execution Phase

During an execution phase, the processor 104 may calculate a first distance between input data or test data 320 including two or more sensor signals associated with a human occupant of the AV and a first class of a set of anchor data 310 using a trained SNN or trained CSNN 322, calculate a second distance between the input data and a second class of the set of anchor data using the trained SNN, and generate an adaptive driving style prediction based on the first distance and the second distance. The set of anchor data may be associated with multiple classes (e.g., a first class 312, a second class 314, a third class 316, etc.). According to one aspect, the first class may be associated with the more defensive (MD) operation, the second class may be associated with having the AV operate the same(S), and the third class may be associated with having the AV operate more aggressively (MA). In this way, the trained SNN may be utilized to predict what a human occupant would prefer based on two or more of the sensor signals received during the execution phase associated with the human occupant.

The trained SNN may be trained as described above with reference to the training phase description. For example, the trained SNN may be trained based on two or more sensor signals received during the training phase, a distance-based loss for the two or more sensor signals from the training phase, and by back-propagating the distance-based loss.

The execution portion 150 may implement the adaptive driving style prediction via the HMI controller 114, the driving automation controller 116, or one or more of the vehicle systems 120. For example, if the adaptive driving style prediction is to have the AV operate more aggressively (MA), the HMI controller 114 may generate a notification for the occupant of the AV and implement the MA driving profile (e.g., faster acceleration, higher velocities, merging into tighter windows, etc.).

### Adaptation During Test Phase or Execution Phase

Additionally, the trained SNN may adapt or fine tune the SNN based on data or the sensor signals received during the test phase or execution phase. For example, this adaptation or fine tuning may occur by adding the newly received data to the existing anchor data on an individual by individual basis. In this way, the SNN model may adapt or personalize itself to each user without entering any retraining phase.

A sensor signal of the two or more of the sensor signals or the two or more of the sensor signals from the training phase may include a heart rate sensor signal, a gaze sensor signal, a pupil size sensor signal, a grip force sensor signal, a controller area network (CAN) signal, or a foot position sensor signal. According to one aspect, the SNN may be a Siamese convolutional neural network (SCNN). The SCNN may include symmetrical convolutional neural networks (CNN).

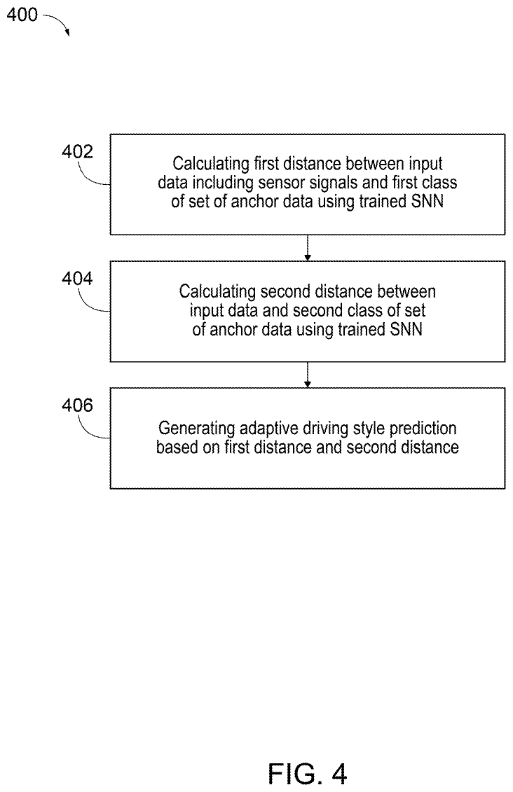

FIG. 4 is an exemplary illustration of a flow diagram for a computer-implemented method 400 for adaptive driving style prediction, according to one aspect. The computer-implemented method 400 for adaptive driving style prediction may include calculating 402 a first distance between input data including two or more sensor signals and a first class of a set of anchor data using a trained SNN, calculating 404 a second distance between the input data and a second class of the set of anchor data using the trained SNN, and generating 406 an adaptive driving style prediction based on the first distance and the second distance. The trained SNN may be trained based on two or more sensor signals received during a training phase, a distance-based loss for the two or more sensor signals from the training phase, and by back-propagating the distance-based loss.

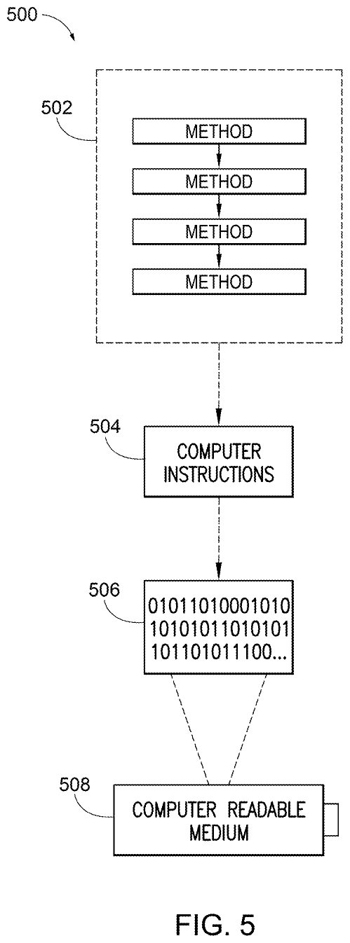

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the computer-implemented method 400 for adaptive driving style prediction of FIG. 4. In another aspect, the processor-executable computer instructions 504 may be configured to implement a system, such as the system 100 for adaptive driving style prediction of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

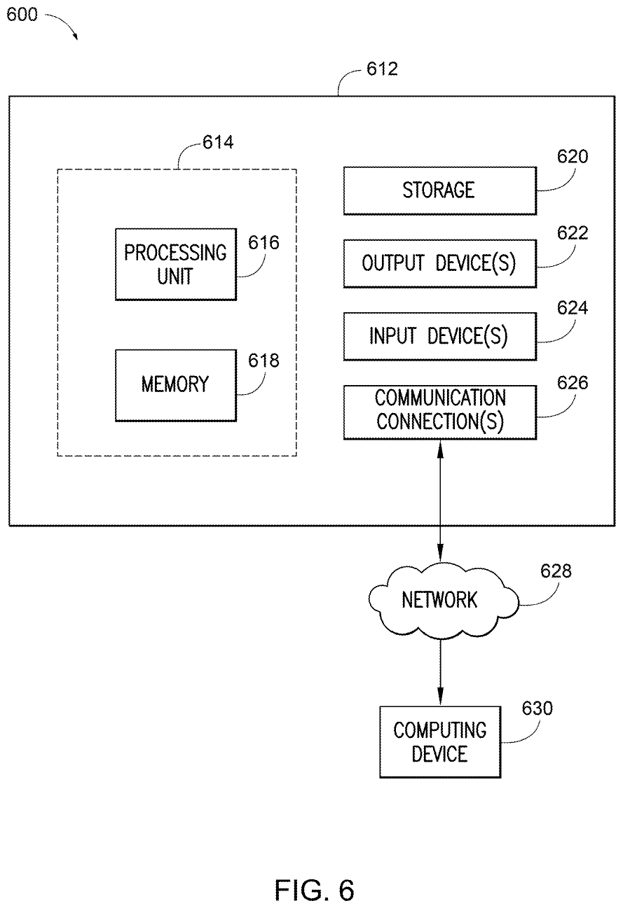

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for Siamese neural network (SNN) based adaptive driving style prediction, comprising:
a set of two or more sensors receiving two or more sensor signals;
a memory storing one or more instructions;
a processor executing one or more of the instructions stored on the memory to perform:
training a SNN based on two or more of the sensor signals as input and a distance-based loss for the two or more sensor signals; and
back-propagating the distance-based loss to further train the SNN.

2. The system for SNN adaptive driving style prediction of claim 1, wherein a sensor signal of the two or more of the sensor signals include a heart rate sensor signal, a gaze sensor signal, a pupil size sensor signal, a grip force sensor signal, a controller area network (CAN) signal, or a foot position sensor signal.

3. The system for SNN adaptive driving style prediction of claim 1, wherein the SNN is a Siamese convolutional neural network (SCNN).

4. The system for SNN adaptive driving style prediction of claim 3, wherein the SCNN includes symmetrical convolutional neural networks (CNN).

5. The system for SNN adaptive driving style prediction of claim 1, wherein the distance-based loss is calculated using Euclidean distance.

6. The system for SNN adaptive driving style prediction of claim 1, wherein the distance-based loss is calculated using a contrastive loss function.

7. The system for SNN adaptive driving style prediction of claim 1, wherein the training the SNN includes learning a similarity function.

8. The system for SNN adaptive driving style prediction of claim 1, wherein the SNN is trained using one-shot learning.

9. The system for SNN adaptive driving style prediction of claim 1, wherein the SNN is trained based on drive context information as input.

10. The system for SNN adaptive driving style prediction of claim 1, wherein the trained SNN outputs an adaptive driving style prediction based on two or more sensor signals received during an execution phase.

11. A system for Siamese neural network (SNN) based adaptive driving style prediction, comprising:
a set of two or more sensors receiving two or more sensor signals as input data;
a memory storing one or more instructions;
a processor executing one or more of the instructions stored on the memory to perform:
calculating a first distance between the input data and a first class of a set of anchor data using a trained SNN;
calculating a second distance between the input data and a second class of the set of anchor data using the trained SNN; and
generating an adaptive driving style prediction based on the first distance and the second distance,
wherein the trained SNN is trained based on two or more sensor signals received during a training phase, a distance-based loss for the two or more sensor signals from the training phase, and by back-propagating the distance-based loss.

12. The system for SNN adaptive driving style prediction of claim 11, wherein a sensor signal of the two or more of the sensor signals or the two or more of the sensor signals from the training phase include a heart rate sensor signal, a gaze sensor signal, a pupil size sensor signal, a grip force sensor signal, a controller area network (CAN) signal, or a foot position sensor signal.

13. The system for SNN adaptive driving style prediction of claim 11, wherein the trained SNN is a Siamese convolutional neural network (SCNN).

14. The system for SNN adaptive driving style prediction of claim 13, wherein the SCNN includes symmetrical convolutional neural networks (CNN).

15. The system for SNN adaptive driving style prediction of claim 11, wherein the distance-based loss is calculated using Euclidean distance.

16. The system for SNN adaptive driving style prediction of claim 11, wherein the distance-based loss is calculated using a contrastive loss function.

17. A computer-implemented method for Siamese neural network (SNN) based adaptive driving style prediction, comprising:
calculating a first distance between input data including two or more sensor signals and a first class of a set of anchor data using a trained SNN;
calculating a second distance between the input data and a second class of the set of anchor data using the trained SNN; and
generating an adaptive driving style prediction based on the first distance and the second distance,
wherein the trained SNN is trained based on two or more sensor signals received during a training phase, a distance-based loss for the two or more sensor signals from the training phase, and by back-propagating the distance-based loss.

18. The computer-implemented method for SNN based adaptive driving style prediction of claim 17, wherein a sensor signal of the two or more of the sensor signals or the two or more of the sensor signals from the training phase include a heart rate sensor signal, a gaze sensor signal, a pupil size sensor signal, a grip force sensor signal, a controller area network (CAN) signal, or a foot position sensor signal.

19. The computer-implemented method for SNN based adaptive driving style prediction of claim 17, wherein the SNN is a Siamese convolutional neural network (SCNN).

20. The computer-implemented method for SNN based adaptive driving style prediction of claim 19, wherein the SCNN includes symmetrical convolutional neural networks (CNN).
